(19) United States
(12) Patent Application Publication
(10) Pub. No.: US 2002/0139874 A1
(43) Pub. Date: Oct. 3, 2002

(54) Developer nozzle for supplying developer to a surface of a semiconductor process wafer

(76) Inventor: Hans-Peter Bach, Finsing (DE)

Correspondence Address: LERNER AND GREENBERG, P.A., POST OFFICE BOX 2480, HOLLYWOOD, FL, 33022-2480, US

(21) Appl. No.: 09/821,857

(22) Filed: Mar. 30, 2001

(51) Int. Cl. B05B 1/00

(52) U.S. Cl. 239/589

(57) ABSTRACT

The developer nozzle is employed to supply developer, in a photographic technique of a photoresist and etching process, for developing photoresist to a surface of a semiconductor process wafer at least partly covered with the photoresist. The face of the developer nozzle that comes to face the surface of the semiconductor wafer and that closes off the developer supply duct in the developer nozzle is flat.

### BACKGROUND OF THE INVENTION

Field of the Invention

The present invention relates to a developer nozzle which, in the photographic technique of a photoresist and etching process, supplies developer for developing photoresist under pressure to a surface at least partly covered with the photoresist and belonging to a semiconductor process wafer. The assembly has a holding and accommodating part into which the developer can be fed, and a nozzle head. The nozzle head is connected to the holding and accommodating part via a nozzle duct extending in the longitudinal direction of the developer nozzle and, at its end opposite the holding and accommodating part, is provided with at least one nozzle opening which extends radially with respect to the nozzle duct and is connected to the nozzle duct. The nozzle head has a permanent closure at the end of the nozzle duct in the longitudinal direction of the developer nozzle.

In the photographic technique of a photoresist and etching process, as is known, developer for developing photoresist is supplied to a surface at least partly covered with this photoresist and belonging to a semiconductor process wafer. Developers used at present are, for example, NMD-W 2.38% consisting in particular of tetramethylammoniumhydroxide, and AZ 830 MIF likewise consisting in particular of tetramethylammoniumhydroxide 2.7%.

FIG. 2 shows a sectional illustration of a prior art developer nozzle that is widely used at present. The prior art nozzle assembly comprises a holding and accommodating part 1 and a nozzle head 2. The two parts can be designed integrally and are made of polychlorotrifluorethylene (PCTFE).

A nozzle duct 3 runs in the developer nozzle. The duct 3 passes through the developer nozzle in its longitudinal direction and, in the area of the nozzle head 2, leads to nozzle openings 4 which extend radially with respect to the longitudinal direction of the nozzle duct 3 and the developer nozzle.

The holding and accommodating part 1 has an opening 5 which has a conical marginal surface which forms an angle of about 30°. A unit for supplying developer and having a holder H (cf. FIGS. 4, 5), such as a tube provided with the holder, can be inserted into the opening 5. It is thereby possible for the holding and accommodating part 1 to be fixed to this holder H by means of a non-illustrated nut and for the tube to be connected to a developer supply, which is not shown either. It will be understood, of course, the developer can also be supplied to the opening 5 in another way.

The developer introduced via the opening 5 into the nozzle duct 3 having a diameter of about 6 mm is fed under pressure to the nozzle openings 4 and emerges outward radially from the latter. In this case, five openings 4, for example, can be provided in the nozzle head 2, as can be seen from FIG. 3, which represents a section III-III of FIG. 2. In the case of five nozzle openings 4, these are arranged at an angle of 72° to one another.

The developer nozzle is guided with its longitudinal extent perpendicular to a surface O of a semiconductor wafer W, so that the developer emerging from the nozzle openings 4 wets the photoresist in or on the surface O as uniformly as possible.

At its end pointing toward the surface O of the semiconductor wafer W, the nozzle head 2 of the prior art developer nozzle has a recess or a depression 6 in the form of a “concave radius”. The concave radius is present in all prior art developer nozzles, since it is viewed as advantageous not least in order to keep the developer nozzle at a specific distance of the order of magnitude of mm from the surface O by means of an air bubble L (cf. FIG. 5) formed under it. This is because a “cushion” of air is formed in the recess 6 and keeps the developer nozzle spaced apart from the surface O as the nozzle is guided over the surface O.

It has been found that, in the existing prior art developer nozzle, wetting problems in the form of bubbles and bead effects occur on the semiconductor process wafers. Although pressure and other parameters in the supply of the developer were changed, it has previously not been possible to avoid these wetting problems or bubbles and bead effects.

It goes without saying that, with the increasingly finer structures of integrated semiconductor circuits, such wetting problems lead to considerable disruption in the development of photoresist during the photoresist and etching process.

### SUMMARY OF THE INVENTION

The object of the present invention is to provide a developer nozzle for supplying developer onto the surface of a semiconductor wafer which overcomes the above-noted deficiencies and disadvantages of the prior art devices and methods of this general kind, and which avoids all wetting problems.

With the above and other objects in view there is provided, in accordance with the invention, a developer nozzle, comprising:

a holding and accommodating part for receiving developer;

a nozzle head communicating with said holding and accommodating part via a nozzle duct extending in a longitudinal direction of the developer nozzle, said nozzle head having formed therein, distally from said holding and accommodating part, at least one nozzle opening communicating with and extending radially from said nozzle duct;

said nozzle head having a permanent closure closing off said nozzle duct in the longitudinal direction of the developer nozzle, said permanent closure having an outer face defining a plane perpendicular to the longitudinal direction of the developer nozzle.

In the case of the invention, therefore, the recess or the concave radius in the nozzle head, previously viewed as essential, is dispensed with. Instead, the permanent closure of the nozzle head is provided with an outer face which covers a plane to which the longitudinal direction of the nozzle head is perpendicular.

In accordance with an added feature of the invention, the holding and accommodating part and said nozzle head are both produced from polytetrafluoroethylene. In accordance with an additional feature of the invention, the nozzle head, at least in an area of said at least one nozzle opening, is produced from polytetrafluoroethylene. That is, instead of PCTFE, the novel assembly utilizes polytetrafluoroethylene (PTFE) as the material for the developer nozzle.

In accordance with a concomitant feature of the invention, the nozzle duct has a diameter of about 6 mm and the nozzle opening or openings have a diameter of about 0.3 mm.

In other words, the developer nozzle is employed, in a photographic technique of a photoresist and etching process, to supply developer for developing photoresist under pressure to a surface of a semiconductor process wafer at least partly covered with the photoresist. The developer nozzle having a holding and accommodating part for receiving developer and a nozzle head communicating with the holding and accommodating part via a nozzle duct extending in a longitudinal direction of the developer nozzle, the nozzle head having formed therein, distally from the holding and accommodating part, at least one nozzle opening communicating with and extending radially from the nozzle duct. The prior art assembly is improved in that the nozzle head has a permanent closure closing off the nozzle duct in the longitudinal direction of the developer nozzle with an outer face defining a planar surface perpendicular to the longitudinal direction of the developer nozzle.

Trials by the inventor have shown that the developer nozzle according to the invention permits high uniformity of the application of developer over the wafer, so that deviations are less than 18 nm, while the existing developer nozzle leads to a uniformity with deviations of up to 25 to 30 nm. In addition, if a plurality of wafers or semiconductor process wafers are treated with the developer nozzle according to the invention, then their mean values in the application of developer are scattered by about 5 nm, while in the case of the existing developer nozzle, there is a scatter of a range of about 20 nm.

Other features which are considered as characteristic for the invention are set forth in the appended claims.

Although the invention is illustrated and described herein as embodied in a developer nozzle for supplying developer to the surface of a semiconductor process wafer, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE DRAWINGS

FIG. 1 is a longitudinal section taken through a developer nozzle according to the invention;

FIG. 2 is a longitudinal section taken through a prior art developer nozzle;

FIG. 3 is a cross section through the developer nozzle taken along the lines III-III in FIG. 1 and in FIG. 2;

FIG. 4 is a side elevational view illustrating the emergence of the developer from the developer nozzle according to the invention; and

FIG. 5 is a side elevational view illustrating the emergence of the developer from a prior art developer nozzle.

### DESCRIPTION OF THE PREFERRED EMBODIMENTS

Mutually corresponding components and parts are identified with the same reference numerals throughout the figures. Reference is had, in this regard, to the description of FIGS. 2 and 3 in the introductory text above.

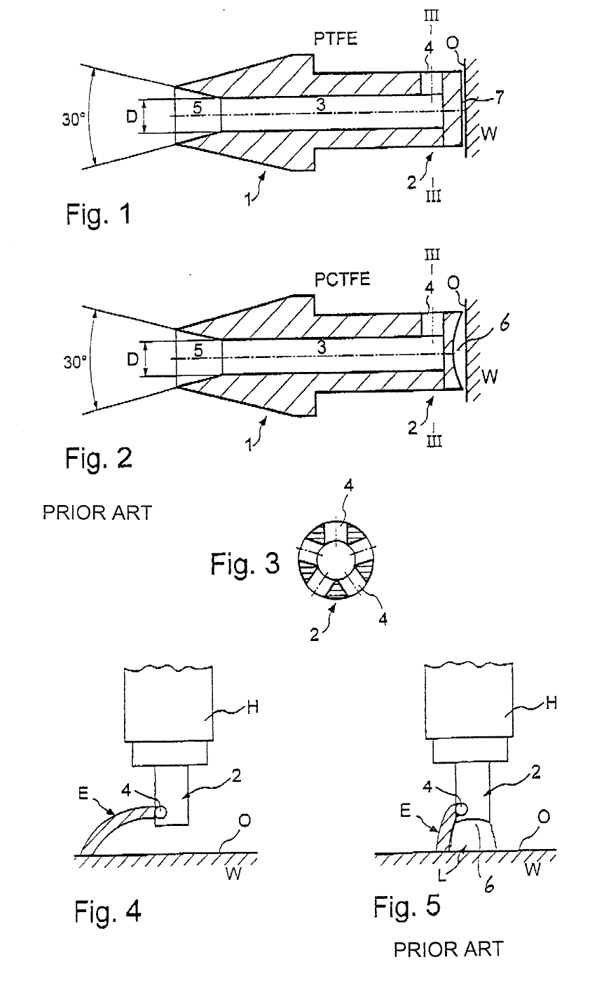

Referring now to the figures of the drawing in detail and first, particularly, to FIG. 1 thereof, there is seen a developer nozzle according to the invention that differs from the prior art developer nozzle of FIG. 2 firstly in that, instead of the recess 6 in the existing developer nozzle, the developer nozzle according to the invention has a flat face 7 at that end of the nozzle duct 3 in the nozzle head 2 which is formed by a permanent closure. In addition, the developer nozzle according to the invention is produced from PTFE instead of PCTFE.

The use of the flat face 7 instead of the depression or recess 6 leads to the application of developer from the holes, having a diameter of about 0.3 mm, in the nozzle openings 4 being capable of being adjusted in stable and uniform fashion on the surface O of the semiconductor wafer W. Merely by means of this measure, wetting problems on the semiconductor wafer W in the form of bubbles and bead effects can largely be ruled out. The wetting problems are even better suppressed if the developer nozzle is specifically produced from PTFE.

The advantages that can be achieved with the invention become clear from a comparison of FIGS. 4 and 5: FIG. 4 shows how the developer E emerges from the nozzle opening 4 of the developer nozzle according to the invention used in the holder H and reaches the surface O of the semiconductor wafer W without disturbance. In contrast, FIG. 5 reveals the formation of the air bubble L underneath the recess 6 in the nozzle head 2 of the prior art developer nozzle. This air bubble L and PCTFE as material for the developer nozzle, at least in the area of the nozzle openings 4, allow the developer E to adhere to the material and the air bubble, which leads to bubble formation and to disadvantageous bead effects.

I claim:

1. A developer nozzle, comprising:
a holding and accommodating part for receiving developer;
a nozzle head communicating with said holding and accommodating part via a nozzle duct extending in a longitudinal direction of the developer nozzle, said nozzle head having formed therein, distally from said holding and accommodating part, at least one nozzle opening communicating with and extending radially from said nozzle duct;
said nozzle head having a permanent closure closing off said nozzle duct in the longitudinal direction of the developer nozzle, said permanent closure having an outer face defining a plane perpendicular to the longitudinal direction of the developer nozzle.

2. The developer nozzle according to claim 1, wherein said holding and accommodating part and said nozzle head are produced from polytetrafluoroethylene.

3. The developer nozzle according to claim 1, wherein said nozzle head, at least in an area of said at least one nozzle opening, is produced from polytetrafluoroethylene.

4. The developer nozzle according to claim 1, wherein said nozzle duct has a diameter of about 6 mm and said at least one nozzle opening has a diameter of about 0.3 mm.

5. In a developer nozzle of the type employed, in a photographic technique of a photoresist and etching process, to supply developer for developing photoresist under pressure to a surface of a semiconductor process wafer at least partly covered with the photoresist, the developer nozzle having a holding and accommodating part for receiving developer and a nozzle head communicating with the holding and accommodating part via a nozzle duct extending in a longitudinal direction of the developer nozzle, the nozzle head having formed therein, distally from the holding and accommodating part, at least one nozzle opening communicating with and extending radially from the nozzle duct, the improvement which comprises:
the nozzle head having a permanent closure closing off the nozzle duct in the longitudinal direction of the developer nozzle and having an outer face defining a planar surface perpendicular to the longitudinal direction of the developer nozzle.
